(19) United States
(12) Patent Application Publication
(10) Pub. No.: US 2010/0115831 A1
(43) Pub. Date: May 13, 2010

(54) Soil treatments with greenhouse gas

(75) Inventor: Stephen Craig Arbogast, Port St. Lucie, FL (US)

Correspondence Address: JAMES C. EAVES JR.;GREENEBAUM DOLL & MCDONALD PLLC, 3500 NATIONAL CITY TOWER, 101 SOUTH FIFTH STREET, LOUISVILLE, KY, 40202, US

(73) Assignee: Green Knight Technologies, LLC

(21) Appl. No.: 12/291,518

(22) Filed: Nov. 10, 2008

(51) Int. Cl. A01G 29/00

(52) U.S. Cl. 47/48.5

(57) ABSTRACT

The present invention relates to a device for facilitating reduction of greenhouse gas emissions. More particularly, the present invention relates to a device for combining greenhouse gas with a surfactant and applying the combination to soil whereby at least a portion of the greenhouse gas is sequestered in the soil or plant matter.

### BACKGROUND OF THE INVENTION

(a) Field of the Invention

The present invention relates to a device for facilitating reduction of greenhouse gas emissions. More particularly, the present invention relates to a device for combining greenhouse gas with a surfactant and applying the combination to soil whereby at least a portion of the greenhouse gas is sequestered in the soil or plant matter.

(b) Description of the Prior Art

Greenhouse gases (GHGs) are gaseous constituents of the atmosphere that trap heat. Increasing levels of greenhouse gas in the atmosphere is considered a significant contributor to climate change. One of the most prevalent greenhouse gases is carbon dioxide (CO₂). The U.S. Environmental Protection Agency, among others, has suggested sequestering CO₂ in forests or geological formations such as depleted oil reservoirs, unmineable coal seams, deep saline formations, or porous rock formations capped by non-porous rock formations. Sequestration of carbon dioxide in plant material is particularly attractive, as the presence of elevated levels of carbon dioxide is known to enhance plant growth.

Two serious problems exist that impair the effectiveness of reducing greenhouse gas emissions by sequestering carbon dioxide in plant material and soil. First, carbon dioxide is not the only greenhouse gas. Hydrofluorocarbons (HFCs), perfluorocarbons (PFCs), sulfur hexafluoride (SF6), and nitrogen triflouride are synthetic, powerful greenhouse gases that are emitted from a variety of industrial sources. These gases are emitted in smaller quantities than CO₂, but have much greater impact on climate change than an equivalent weight of CO₂. Nitrous oxide is a major greenhouse gas with, over a 100 year period, a 296 fold greater impact on climate change than an equal weight of CO₂. Methane is another greenhouse gas with a global warming potential 23 times that of an equivalent weight of carbon dioxide over a 100 year period. Carbon monoxide has an indirect effect on climate change, reacting with hydroxyl radicals in the atmosphere that could otherwise react with and remove methane. Serious efforts to combat climate change must remediate greenhouse gases besides carbon dioxide.

The second problem with sequestering carbon dioxide in plant material and soil is that CO₂ is often produced in conjunction with other compounds. Stack gas emitted from fossil fuel-fired power plants contains carbon dioxide, sulfur dioxide, mono-nitrogen oxides (NOX), sulfuric acid, hydrochloric acid, hydrogen fluoride, and carbon monoxide. It is necessary to separate carbon dioxide out of the mixture of gases comprising stack gas before soil sequestration. Several components of stack gas, particularly sulfur dioxide, hydrogen fluoride, and hydrochloric acid, are acidic. When unfiltered stack gas is introduced into soil, it lowers the pH of the surrounding soil. Acidic soil can inhibit or prevent plant growth, which decreases the availability of growing plants to uptake and sequester carbon dioxide. Separation of carbon dioxide from the stack gas mixture is very expensive with current technology. The same problem may arise with other greenhouse gases that are produced in conjunction with acidic chemicals or that are acidic themselves. Consequently, there is an unmet need for a method of sequestering greenhouse gas in plant material and soil that is not specific to carbon dioxide and does require the separation of acidic components.

### SUMMARY OF THE INVENTION

The present invention relates to a device for facilitating reduction of greenhouse gas emissions. More particularly, the present invention relates to a device for combining greenhouse gas with a surfactant and applying the combination to soil whereby at least a portion of the greenhouse gas is sequestered in the soil or plant matter. The use of a basic surfactant buffers the acidity of the GHG or other gases mixed with the GHG. This buffering allows the GHG to be sequestered in soil without requiring the separation of acidic components or preventing plant growth.

In one embodiment of the invention, stack gas, including one or more GHG, is combined with a surfactant. This combination is then applied to soil by subsurface injection. At least a portion of any carbon dioxide in the stack gas is uptaken by plants in the soil. The remaining GHGs in the stack gas remain in the soil for a period of time. The stack gases are generally acidic and can negatively effect plant growth by lowering the soil pH. A basic surfactant is used, which buffers the acidity of the stack gas and renders the combination neutral in the soil. The uptake of any carbon dioxide in the stack gas at the level of plant roots or leaves will enhance plant growth.

Studies have shown that some surfactants can increase the soil penetration of aqueous solutions. Surfactants increase the soil penetration of carbonated water by 15-85% depending on soil characteristics. Penetration in fine particle clay soils may increase 15% whereas sandy soils may show an increased penetration of 85%. An additional advantage of the use of surfactants is the decrease in water use. An 85% increase in soil penetration slows evaporation by approximately 50% due to the increased distance from the soil surface diffusion point. Increased soil penetration will result in GHGs being retained in the soil for a longer period of time than a combination of GHG, water, and a non-surfactant buffer and will also allow more time for plants to uptake any carbon dioxide.

In some embodiments of the present invention, an aqueous solution comprising surfactants that are effective in neutralizing acidity is combined with an acidic GHG or a mixture of a non-acidic GHG with one or more acidic components to provide a mixture having elevated GHG levels. The concentration of available GHG (including as a solute, adsorbent, or gas) that is at least 50% greater, at least 100%, at least 200% greater, or at least 500% greater than would have resulted without providing a greenhouse gas source other than ambient air. For example, the water may be combined with the greenhouse gas prior to, after, or during mixing of the water with the surfactant. If carbon dioxide is one of the greenhouse gases, the resulting solution may be carbonated sufficiently to provide generation of bubbles at nucleation sites, or to at least comprise carbonic acid or reaction products of carbonic acid, such that the solution can deliver additional carbon to the plants. The surfactants may also be added to carbonated water or other carbonated liquids that have been or will be combined with GHG.

The invention is also directed to methods of applying compositions to soil or plants in the presence of elevated greenhouse gas levels, wherein the compositions-comprise surfactants derived from natural lipids, such as vegetable oils and naturally occurring fatty acids or their naturally occurring derivatives such as mono-, di-, or triglycerides or phospholipids. In some embodiments, sequestration of GHG comprises application of greenhouse gas combined with bio-derived surfactants obtained from natural oils such as soybean and castor oils, wherein the surfactants are obtained by esterification of the oils to add alkoxy groups such as methoxy, ethoxy, or propoxy groups. In some embodiments, the bio-derived surfactants have aliphatic chains with relatively high carbon numbers, such as 14 or more carbons, 16 or more carbons, or 18 or more carbons. In one embodiment, the carbon number is from 16 to 18, and in a related embodiment, the bio-derived surfactant primarily comprises surfactants having a carbon number of 16 or 18. In some embodiments, the surfactants have a relatively high hydrophile-lipophile balance (HLB) value, such as greater than or equal to 5 or greater than or equal to 6.

Ethoxylation is a useful technique to obtain a bio-derived surfactant with a relatively high HLB value that is the product of a natural fatty acid. This technique allows a chain of hydrophilic ethoxy groups to be readily added to the molecule. In ethoxylation, ethylene oxide is added to fatty acids, typically in the presence of potassium hydroxide, resulting in the addition of multiple ethoxy groups to the acid.

In a preferred embodiment, the bio-derived surfactant comprises an ethoxylated fatty acid, wherein the fatty acid has a carbon number of sixteen or greater and/or at least 5 ethoxy groups, specifically at least 10 ethoxy groups, and more specifically at least 20 ethoxy groups, such as between 5 and 80 ethoxy groups, or between 10 and 60 ethoxy groups, or between 15 and 55 ethoxy groups. In one embodiment, the bio-derived surfactant is obtained by esterification or epoxidation of soybean or castor oil. More generally, but by way of example only, the bio-derived surfactant may be derived from any of the following lipids: soybean oil, castor oil, cottonseed oil, linseed oil, canola oil, safflower oil, sunflower oil, peanut oil, olive oil, sesame oil, coconut oil, walnut oil or other nut oils, flax oil, neem oil, meadowfoam oil, other seed oils, fish oils, animal fats, and the like. Exemplary fatty acids include omega-3 fatty acids such as alpha-linolenic acid, stearidonic acid, eicosapentaenoic acid, docosahexaenoic acid, and so forth; omega-6 fatty acids such as linoleic acid, gamma-linolenic acid, dihomo-gamma-linolenic acid, arachidonic acid, calendic acid, and the like; omega-9 fatty acids such as oleic acid, erucic acid, elaidic acid, and the like; saturated fatty acids such as myristic acid, palmitic acid, stearic acid, dihydroxystearic acid, arachidic acid (eicosanoic acid), behenic acid (docosanoic acid), lignoceric acid; and other fatty acids including various conjugated linoleic acids, omega-5 fatty acids such as myristoleic acid, malvalic acid, sterculic acid. Natural waxes or the fatty acids therefrom may also be used, particularly ester waxes such as straight chain ester waxes; examples include jojoba oil, carnauba wax, beeswax, candellia wax, and the like.

In some embodiments, the bio-derived surfactants of the present invention comprise surfactants derived from naturally occurring fatty acids that are unsaturated, such as omega-3, omega-six, or omega-nine fatty acids, and wherein the aliphatic tail of the surfactant has not been hydrogenated, such that it has remained unsaturated.

In some embodiments, bio-derived surfactants are obtained from two or more vegetable oil sources, such as from mixtures of any two or more of the vegetable oils mentioned herein. Alternatively, two or more vegetable oils may be reconstituted to form a reconstituted oil according to known methods such as those described in U.S. Pat. No. 6,258,965, “Reconstituted Meadowfoam Oil,” issued Jul. 10, 2001 to A. J. O'Lenick, Jr., and U.S. Pat. No. 6,013,818, “Reconstituted Meadowfoam Oil,” issued Jan. 11, 2001 to A. J. O'Lenick, Jr., both of which are herein incorporated by reference to the extent that it is noncontradictory herewith. The O'Lenick references describe processes in which one or more oils of natural origin are transesterified under conditions of high temperature in the presence of a catalyst to make a “reconstituted product” having an altered alkyl distribution and consequently altered chemical and physical properties. While surfactants obtained from natural lipids are useful, it is recognized that identical materials obtained from synthetic raw materials can be created and, in some embodiments, are still within the scope of the present invention.

More particularly, the present invention comprises a device having a main body including a liquid outlet, a gas inlet attached to the main body, and a liquid inlet attached to the main body. The liquid outlet is in fluid communication with the liquid inlet and the gas inlet, such that a greenhouse gas can be applied under pressure to the gas inlet and a surfactant can be applied under pressure to the liquid inlet to dispense a mixture of greenhouse gas and surfactant from the liquid outlet. In a preferred embodiment, the greenhouse gas is acidic or is a component of a mixture of gases, one or more of which is acidic. In this embodiment, the surfactant is basic and effective in substantially neutralizing the acidity of the acidic gas or gases. In a preferred embodiment, the surfactant is an ethoxylated fatty acid ester derived from plant oil, wherein the fatty acid has a carbon number of sixteen or greater, at least twenty ethoxy groups, and a HLB value of at least about six.

### BRIEF DESCRIPTION OF THE DRAWINGS

A better understanding of the present invention will be had upon reference to the following description in conjunction with the accompanying drawings, wherein:

FIG. 1 depicts a mixing section for combining pressurized greenhouse gas with a surfactant solution according to the present invention;

FIG. 2 depicts a subsurface injection unit according to the present invention for delivering an aqueous solution in the presence of pressurized greenhouse gas into the soil;

FIG. 3 depicts the end of the main body of a subsurface injection unit according to the present invention;

FIG. 4 depicts the above ground control system for use with a subsurface injection unit according to the present invention.

### DEFINITIONS

As used herein, “bio-derived” compounds are those produced from a naturally occurring substance obtained from a plant, animal, or microbe, and then modified via chemical reaction. Modification can include esterification of fatty acids (e.g., ethoxylation, methoxylation, propoxylation, etc.), transesterification of an oil (e.g., reaction of an alcohol with a glyceride to form esters of the fatty acid portions of the glycerides), etc. Hydrogenation or other steps may also be considered.

As used herein, “greenhouse gas” or “GHG” refers to a gas or mixture of gases comprising one or more of the gases recognized as a greenhouse gas by the U.S. Environmental Protection Agency and the Kyoto Protocol, including carbon dioxide, nitrous oxide, methane, hydrofluorocarbons, perfluorocarbons, and sulfur hexafluorides, or nitrogen trifluoride.

As used herein, “soil” refers to all media capable of supporting the growth of plants and may include humus, sand, manure, compost and the like. Soil may be substantially uniform in properties or substantially heterogeneous at a variety of scales. For example, there may be multiple strata such as a layer of sandy soil above a less permeable layer of clay-rich soil. There may also be aggregates of differing soil types, or clumps of matter such as vegetable matter, clays, minerals, fertilizers, etc., dispersed within the soil. The soil may also contain manmade ducts, tubes, pipes, shafts, etc., for convenient irrigation or treatment with nutrients, pesticides, etc., though such structures are generally understood to not be part of the soil itself. The soil may be substantially flat, in mounds, interspersed with furrows, in pots or other containers, in the outdoors or in a greenhouse, etc. In some cases, the soil is part of an outdoor agricultural field dedicated to growing of one or more marketable crops. In some cases, the soil is part of an outdoor field dedicated to the sequestration of greenhouse gas. The field may comprise a single contiguous area or may be broken up into a plurality of nearby units controlled by the same entity.

### DETAILED DESCRIPTION OF THE PREFERRED EMBODIMENT

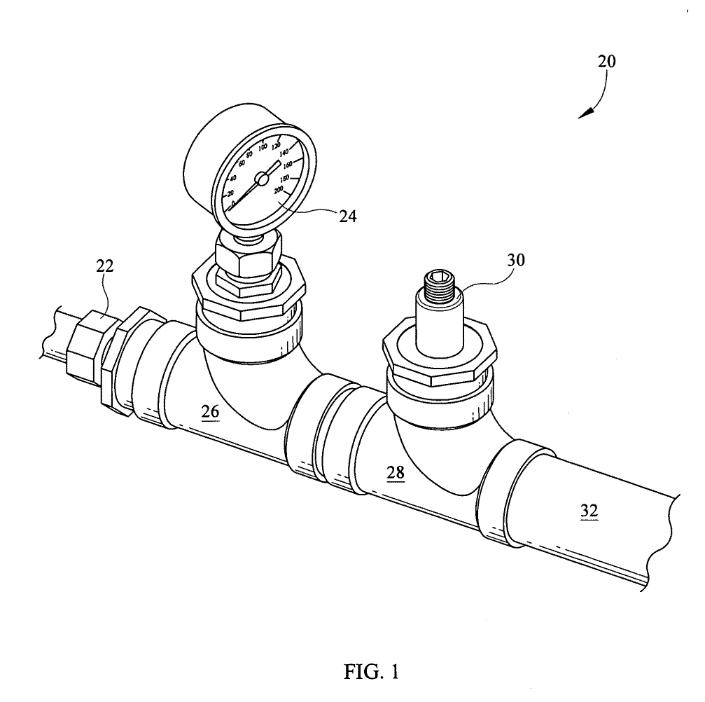

With reference to FIGS. 1-4, the method for facilitating reduction in greenhouse gas emissions through the application of greenhouse gas in combination with a surfactant to soil is shown and described.

In one embodiment of the invention, stack gas, including one or more GHG, is combined with a surfactant. This combination is then applied to soil by subsurface injection. At least a portion of any carbon dioxide in the stack gas is uptaken by plants in the soil. The remaining GHGs in the stack gas remain in the soil for a period of time. The stack gas are generally acidic and may negatively effect plant growth by lowering the soil pH. A basic surfactant is used, which buffers the acidity of the stack gas and can render the combination neutral in the soil. The uptake of any carbon dioxide in the stack gas at the level of plant roots will enhance plant growth.

Greenhouse gas is made available at the site of sequestration. The GHG may be pure or a component of a mixture of gases. In one embodiment, the greenhouse gas is transported for the location of its production to the site of sequestration in a pressurized tank. The GHG may be transported at a sufficiently high pressure to convert the gas into a liquid. In another embodiment, the GHG passes directly from the location of its production to the site of sequestration in a pipe, duct, tube, shaft, or other such means.

Surfactant is made available at the site of sequestration. In one embodiment, the surfactant is in an aqueous solution. The surfactant and greenhouse gas may be combined at the site of sequestration or before transport to the site of sequestration.

FIG. 1 is a drawing of a system for combining greenhouse gas with an aqueous solution of a surfactant. The drawing depicts an injection unit 20 for an above-ground spray application system for combining greenhouse gas and an aqueous solution of a surfactant. The injection unit 20 shown has a liquid inlet line 22 for receiving a metered flow of an aqueous solution of a surfactant. A pressure gauge 24 in a first sweep-T junction 26 allows the greenhouse gas pressure into the injection unit 20 to be monitored. A gas inlet line 30 allows greenhouse gas to merge into the liquid flow in a second sweep-T junction 28. The combined liquid and greenhouse gas flows enter a continuation segment 32 where greenhouse gas contact with the liquid continues under pressure, and from when it may be delivered to a spray tank or other delivery system (not shown).

Sequestration of carbon dioxide in plant material is particularly attractive, as elevated levels of carbon dioxide is known to enhance plant growth. Studies have shown that plant enhancement is particularly strong when plants are exposed to high concentrations of carbon dioxide at the roots (see Ainsworth E. A., et al. A meta-analysis of elevated [CO2] effects on soybean (Glycine max) physiology, growth and yield. Global Change Biology (2002) 8, 695-709 and Rogers H. H., et al. Response of plant roots to elevated atmospheric carbon dioxide. Plant, Cell and Environment (1992) 15, 749-752). In a preferred embodiment, the combined surfactant and greenhouse gas, including carbon dioxide, may be delivered to the soil via subsurface injection at or near the level of plant roots.

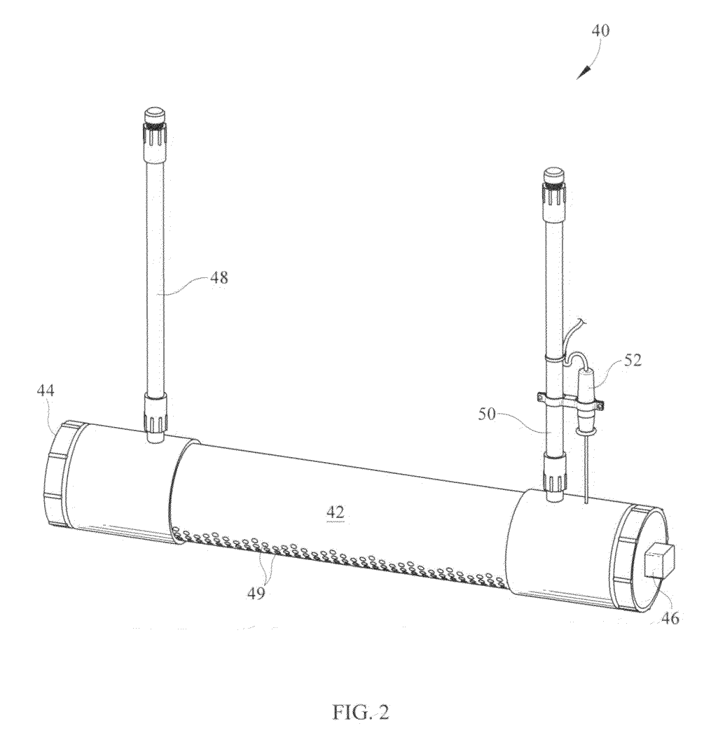

FIG. 2 depicts a subsurface injection unit 40 for delivering an aqueous surfactant solution in the presence of pressurized greenhouse gas into the soil while buried a predetermined depth, such as from 20 to 80 cm below the surface. The subsurface injection unit 40 has a main body 42, in this 8-inch diameter PVC piping, with end caps 44 and 46. A liquid inlet 48 allows metered aqueous solutions of surfactants to be delivered into the main body 42, which has a liquid outlet 49 (fine holes drilled in the lower half of the main body) through which the pressurized liquid is exuded into the soil. A gas inlet 50 allows pressurized greenhouse gas to be supplied to the main body 42, from whence it can be delivered with the liquid into the surrounding soil through the fine holes in the main body. A thermocouple 52 extends through an end cap 46 to allow temperature to be monitored near the greenhouse gas inlet line to allow the system to be controlled to prevent freezing of the liquid.

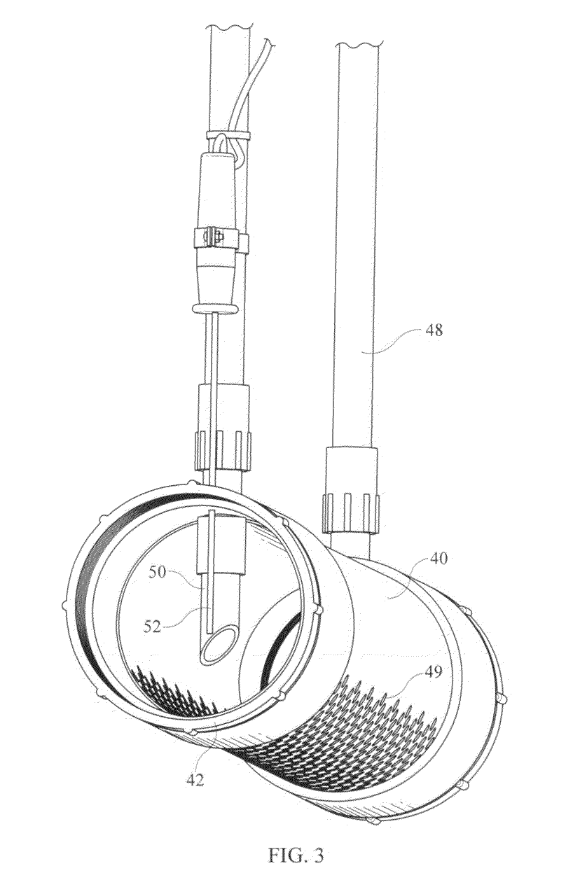

FIG. 3 depicts the end of the main body 42 of the subsurface injection unit 40 with end cap 46 removed to allow the interior of the subsurface injection unit 40 to be seen. The thermocouple 52 near the end of the gas inlet 50 is visible.

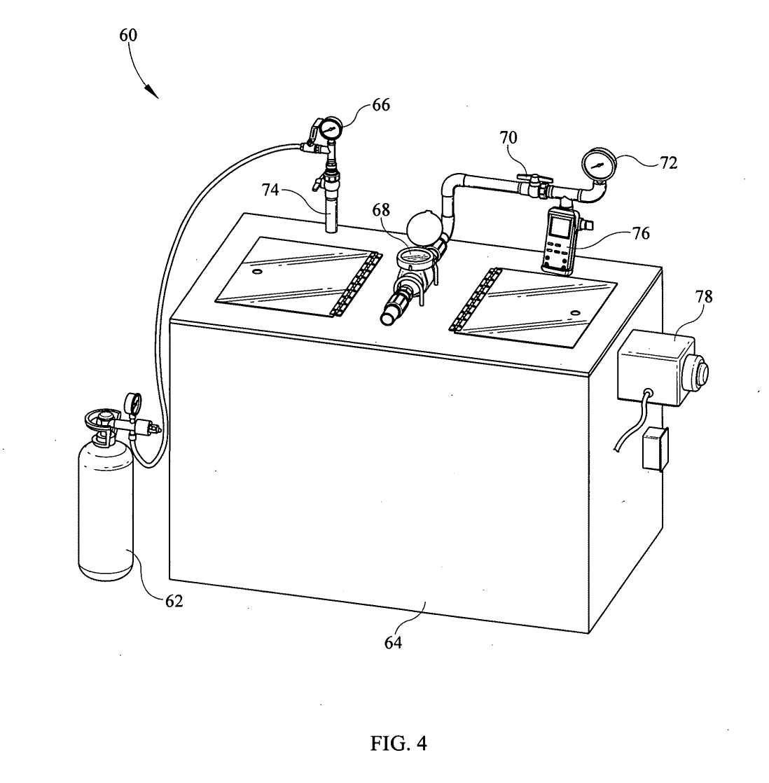

FIG. 4 is a drawing of the above-ground control system 60 for use with the subsurface injection unit 40 of FIGS. 2 and 3. A tank 62 serves as a source of pressurized greenhouse gas that flows into gas inlet 74 with pressure monitored by a gas pressure gauge 66. An aqueous solution of a surfactant is provided from a liquid tank (not shown) which delivers liquid to a peristaltic metering pump 78 whose output pressure is monitored by a liquid pressure gauge 72 and whose mass flow rate is monitored by a mass flow meter 68. A liquid valve 70 is shown in the open position. The liquid exiting from the mass flow meter 68 can pass through a hose (not shown) or other tubing to connect to a subsurface injection system (not shown). Inside the control box 64 is a greenhouse gas sensor (not visible). A digital thermometer 76 monitors line temperatures. The control box 64 can be placed over a buried injection line to monitor escaping greenhouse gas that emerges from the soil.

In a preferred embodiment, application is by subsurface injection via buried piping or other such means. Buried piping may be oriented substantially parallel to ground level, substantially perpendicular to ground level, or at an incline. Application may be directed to specific regions of the soil, such as the soil at the base of a plant, or may be substantially uniformly applied to the soil of an agricultural tract. Application may be directed to specific regions of the soil, such as the soil at the base of one plant species but not at the soil at the base of another plant species.

Soil may be treated in the field, or pretreated before being delivered to an agricultural site. Soil preparation prior to application of greenhouse gas and surfactant using the device of the present invention can include tilling-free mechanical treatment of soil, including cutting or slits or formation of holes, trenches, or other structures to allow for liquids or gases to more readily enter the soil.

Soil treatment may also be conducted in conjunction with covering materials such as plastic films over the ground. Film may be applied before or after application of the aqueous compounds of the present invention. For example, in one embodiment, a film may be applied to the soil, and then it may be pushed into the soil at spaced apart regions. The film may be pierced in those regions where it penetrates into the soil, and then the aqueous solution may be applied such that it enters the soil through the pierced covering in the regions where the covering has been pushed into the soil. In one example, a four-centimeter deep hole may be formed in the soil into which a liter or more of the aqueous solution is applied.

With or without films or other ground coverings present, application of the aqueous solution may be done at the base of an existing plant or in the locales where seeds have been or will be planted.

The aqueous solution, as applied to the soil, to weeds, or to crops or other plants, may comprise any effective amount of the surfactant, such as at a concentration of least about any of the following: 0.05%, 0.1%, 0.2%, 0.3%, 0.5%, 1%, 1.5%, 2%, 3%, 5%, 10%, or 20%. The concentration may also be less than about any of the following 100%, 50%, 25%, 20%, 10%, 5%, and 3%, and ranges may be formed from any suitable pair of the aforementioned upper and lower bounds, such as from about 0.1% to about 15%. An effective amount of surfactant is defined as an amount of surfactant capable of buffering the acidity of the greenhouse gas, resulting in an aqueous solution with a pH suitable for plant growth, while not being present at such high levels as to cause the surfactant to substantially prevent plant growth. Other ingredients of the aqueous solution may include oils, emulsifiers, thickeners, film-forming agents, particles such as zeolites, calcium carbonate, mica, etc., as well as fertilizers, pesticides, nutrients, beneficial bacteria, etc.

Application of the surfactant can be in a diluted aqueous solution, or via a concentrated solution (e.g., concentrations of 10% to 100%). When a concentrated solution is applied, it may be subsequently diluted by irrigation, rainwater, etc., such that a more dilute solution is distributed through the soil.

A variety of surfactants may be effective for use in the present invention, particularly certain bio-derived surfactants. Formation of a bio-derived surfactant from a naturally occurring lipid can be done by any known method such as esterification, Fischer esterification, epoxidation, etc. Prior to the formation of a surfactant, fatty acids may be liberated from natural lipids by, for example, triglyceride hydrolysis, which separates the fatty acids from glycerol. The fatty acids may then be reacted to yield the bio-based surfactants useful in the present invention. In one version, the reaction of the fatty acids is with an alcohol or an epoxide. Exemplary alcohols include methanol, ethanol, propanol, and other primary or secondary alkyl alcohols.

In ethoxylation, ethylene oxide is added to fatty acids, typically in the presence of potassium hydroxide, resulting in the addition of multiple ethoxy groups to the acid. In order to obtain a bio-derived surfactant with a relatively high HLB value that is the product of a natural fatty acid, ethoxylation is a useful technique because a chain of hydrophilic ethoxy groups can be readily added to the molecule. Thus, in many embodiments of the present invention, the bio-derived surfactants are obtained through a simple operation or small number of operations from the natural raw materials themselves, such as via hydrolysis and esterification (e.g., ethoxylation) or via esterification alone. In other embodiments, a hydrogenation step may also be included prior to or after esterification (e.g in the formation of alcohols, hydrogenation may follow methylation of a fatty acid).

The foregoing detailed description is given primarily for clearness of understanding and no unnecessary limitations are to be understood therefrom for modifications can be made by those skilled in the art upon reading this disclosure and may be made without departing from the spirit of the invention and scope of the appended claims.

What is claimed is:

1. A device comprising:
a main body including a liquid outlet;
a gas inlet attached to the main body;
and a liquid inlet attached to the main body, said liquid outlet being in fluid communication with said liquid inlet and said gas inlet, such that a greenhouse gas can be applied under pressure to said gas inlet and a surfactant can be applied under pressure to said liquid inlet to dispense a mixture thereof from said liquid outlet.

2. The device of claim 1, wherein the greenhouse gas is produced by an entity engaged in the reaction of fossil fuels.

3. The device of claim 2, wherein the entity engaged in the reaction of fossil fuels is a power plant.

4. The device of claim 1, wherein the greenhouse gas is a component of a mixture of gases.

5. The device of claim 4, wherein one or more components of the mixture of gases is acidic.

6. The device of claim 5, wherein the surfactant is effective in substantially neutralizing the acidity of the mixture of gases.

7. The device of claim 4, wherein at least one of the components of the mixture of gases is a greenhouse gas other than carbon dioxide.

8. The device of claim 1, wherein the greenhouse gas is acidic.

9. The device of claim 8, wherein the surfactant is effective in neutralizing the acidity of the greenhouse gas.

10. The device of claim 1, wherein, wherein the surfactant is bio-derived.

11. The device of claim 1, wherein the surfactant is derived by esterification of lipid having a carbon number of 16 or higher, said surfactant having an HLB value greater than about 6.

12. The device of claim 1, wherein the surfactant is in an aqueous solution.

13. The device of claim 1, wherein the main body is located underground in soil.

14. The device of claim 13, wherein at least a portion of the greenhouse gas is sequestered in soil or plant matter.

15. The device of claim 1, wherein the liquid outlet is one or more holes in the main body.

16. The device of claim 1, wherein the liquid inlet and the gas inlet are in fluid communication.
